(19) United States
(12) Patent Application Publication
(10) Pub. No.: US 2020/0159777 A1
(43) Pub. Date: May 21, 2020

(54) SIMPLIFYING ELECTRONIC COMMUNICATION BASED ON DYNAMICALLY STRUCTURED CONTACT ENTRIES

(71) Applicant: International Business Machines Corporation, Armonk, NY (US)

(72) Inventors: Komminist Weldemariam, Ottawa (CA); Elizabeth Ondula, Los Angeles, CA (US); Nelson K. Bore, Lessos (KE); Shikhar Kwatra, Durham, NC (US)

(21) Appl. No.: 16/197,492

(22) Filed: Nov. 21, 2018

(51) Int. Cl. G06F 16/9035; G06F 21/31; G06F 9/50; G06N 3/08; G06N 3/04; H04L 29/08

(52) U.S. Cl. CPC G06F 16/9035; G06F 21/316; H04L 67/306; G06N 3/08; G06N 3/04; G06F 9/5033

(57) ABSTRACT

A first set of data signals is received from a first user device associated with a first user. Temporal properties associated with the first user are determined from the first set of data signals. The temporal properties may include a current cognitive state of the first user and environment context associated the first user. Responsive to detecting the temporal properties, contact entries associated with the first user device are dynamically structured. A second user is selected from the dynamically structured contact entries. The first user device may be automatically or autonomously triggered to initiate a communication with the second user via the first user device.

### BACKGROUND

The present application relates generally to computers and computer applications, and more particularly to facilitating electronic communications.

Devices and software that store contact information traditionally organize such information based on factors such as call frequencies, user relationships (e.g., family member, work place colleague), and user-supplied inputs. For example, user's contact entries can be reorganized or dynamically adjusted in alphabetical order, order of frequency of calls, user-driven arrangement, or based on some characteristics of the profiles (e.g., based on geographic location, job profile, organization type, and/or others). An organization of user's contacts entries can be structured by group (e.g., an app group) based on desirability or characteristics (e.g., events, family circle, interest group, and/or others). These groups can be formed manually or suggested by an automated system, which may take into consideration engagements between the user and secondary user(s) in the contact entries (e.g., call frequencies, number of posts/comments/likes among each other, and/or others).

When a user desires to contact a person or group of persons (e.g., via phone call, text message to a secondary user or group of persons, posting a message to person or group of persons), the user first needs to locate the recipient person or a group, e.g., by browsing (e.g., via manual browsing) through the contact entries or by interacting via a voice-based mechanism. If the contact entries are not structured or organized in an easily accessible manner, additional steps or browsing may be needed to precisely locate the recipient.

### BRIEF SUMMARY

A computer-implemented method and system, which simplify electronic communications, may be provided. The method, in one aspect, may include receiving a first set of data signals from a first user device associated with a first user. The method may also include detecting temporal properties associated with the first user from the first set of data signals. The temporal properties may include at least a current cognitive state of the first user and environment context associated the first user. The method may also include, responsive to detecting the temporal properties, dynamically structuring contact entries associated with the first user device. The method may also include selecting at least one second user from the dynamically structured contact entries. The method may further include triggering the first user device to initiate a communication with the at least one second user via the first user device.

A system, in one aspect, may include at least one hardware processor coupled with a memory device. The at least one hardware processor operable to receive a first set of data signals from a first user device associated with a first user. The at least one hardware processor also operable to detect temporal properties associated with the first user from the first set of data signals, the temporal properties comprising at least a current cognitive state of the first user and environment context associated the first user. The at least one hardware processor also operable to, responsive to detecting the temporal properties, dynamically structure contact entries associated with the first user device. The at least one hardware processor also operable to select at least one second user from the dynamically structured contact entries. The at least one hardware processor also operable to trigger the first user device to initiate a communication with the at least one second user via the first user device.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram illustrating components of a computing system in one embodiment.

FIG. 2 is a flow diagram illustrating adjusting of a user contact entry using affinity measures, according to one embodiment.

FIG. 3 is a flow diagram illustrating a method of dynamically adjusting contact entries based on detected or predicted temporal properties of a user in real-time, according to one embodiment.

FIG. 4 is a flow diagram illustrating a method of dynamically generating user assistive actions, according one embodiment.

FIG. 5 shows an implementation example of a three-layer neural network model illustrating contact adjustment based on multiple weighted parameters trained over configurable time period T, in one embodiment.

FIG. 6 is a diagram showing components of a system in one embodiment, which simplifies electronic communication based on dynamically structured or adjusted contact entries.

FIG. 7 illustrates a schematic of an example computer or processing system that may implement a system according to one embodiment.

### DETAILED DESCRIPTION

A method, system, and techniques are disclosed, which dynamically structure contact entities for a user based on predicted user temporal properties. In one aspect, a first set of data signals from a first user device may be received. One or more temporal properties such as, but not limited to, cognitive state, contextual factors, temporary event specific characteristic, associated with a first user may be detected or determined from the received data signals. The first user's contact entries stored on or by the first user device may be dynamically structured or adjusted, in response to the detected temporal properties for efficient electronic communication and amelioration action. In one aspect, the user contact entries may be structured or adjusted based on one or more learned affinity measures.

In some circumstances, a user (referred to also as a first user for explanation sake only) may want to communicate with one or more other users (also referred to as a second user) from contract entries that are relevant to the first user's temporal context and cognitive state. For instance, consider the following specific example scenarios:

Scenario 1—A user may be put in an “agitated” or “confused” state or circumstance and may want to immediately contact a relevant person or user group from the first user device's contact entries. The device of the present disclosure may dynamically adjust the contact entries (e.g., including creating instant group) to assist the user, and possibly suggest whom to contact or communicate, in that particular cognitive state, by sensing the interplay of a user's cognitive and affective states and contextual situation(s), and by combining evidences from multiple inputs.

In one aspect, the device of the present disclosure may infer cognitive and contextual affinities between a profile of a user and each account entry of the device's contact entries; structure the user contact list on the user device based on inferred cognitive and contextual affinities; receive or predicting temporal “properties” of a user (e.g., cognitive state, contextual factors, temporary characteristic, event specific factors) from various input sources that may lead the user to interact with a contact (e.g., making a phone call, sending a message on an app to an individual or groups); dynamically select or compose a contact entry or group to effectively facilitate the user's electronic communication.

As another example, scenario, the device of the present disclosure may automatically detect that the user has encountered a particular situation (e.g., disaster caused by natural calamities such as flood or earthquake), allow the user to immediately contact the appropriate recipient such as a friend or family (one or more second users), for instance, to request help, or to notify the one or more second users of the first user's situation, for instance, allow for real time response in particular situations.

Contact entries can be stored on mobile phone, social media apps, and/or others. The contact entries can form a cohort of skillful social network contact entries, which can be leveraged when a user is in need of assistance. In one aspect, the methodology of the present disclosure structures or organizes contact entries stored in memory according to cognitive and contextual properties (“affinities”) with respect to the user (temporal) scenario, finding (and/or automatically contacting) a contact entry or group that can serve the user's need at that particular time and context.

In some embodiments, the methodology of the present disclosure dynamically adjusts contact entities of a user stored on the user device based on analysis of learned temporal properties (contextual, cognitive and affective states) of a user, and thus the user can be served according to the user's temporal properties or context. In some embodiments, one or more applications and/or devices may be instrumented with code or sensors to intercept or receive a plurality of data points associated with the current context of the user. One or more applications and/or devices which may be instrumented may include a mobile phone, a messaging app, a social network app, electronic mail application (e-mail app), a voice-enabled device, or another device or app, which maintain a user contact lists or entries. The data points are analyzed to detect the current context and adjust the contact entries on the one or more devices or applications accordingly.

In some embodiments, the disclosed system can be automatically triggered while running in the background to monitor interactions, communications or engagements (including in calls, social media posting, short message service (SMS), group posting in an app) of the user with one or more second users from the contact entries and to infer cognitive and affective signals. The disclosed system which simplifies an electronic communication can be triggered in a number of ways. In one aspect, the system may be triggered when a new contact is added (or a group is created) to the user contact list. In another aspect, the system is triggered based on user-specified rules. In further aspect, the system can be based on an advanced triggering mechanism such as inference from a new (e.g., cognitive, affective, contextual) affinity between a user and a second user in the contact list, sensed or predicted user interacting with the contact list.

One or more behavioral aspects of a first user in relation to the other one or more users in the first user contact entries is identified from a plurality of data sources using a custom trained machine learning algorithm. For instance, a machine learning algorithm may be run using historical pattern data comprising timestamp and location metrics and associated user behavior data to train a machine learning model to recognize or identify one or more behavioral aspects of a first user. The identified or learned behavioral aspects of the user may include a cognitive state, context (e.g., including detected event from audio conversation), user relationship, and/or others. In one embodiment, the method of identifying the behavioral aspects may also include associating geo-spatial and temporal metric data (which may be recorded from one or more Internet of Things (IoT) enabled sensors and/or alternate computing devices such as activity tracking devices like a smartwatch or another device) such as longitude and latitude coordinates with time parameter metric as well as with a particular activity performed by the user; learning or detecting cognitive state, e.g., angry, calm, frustrated, happy, or another cognitive state, of a user using, e.g., visual analytics performed by Internet Protocol (IP) cameras in the vicinity; and inferring the user's contextual activities from various input sources, for example, such as IoT sensor feeds such as audio and visual data captured via Internet Protocol (IP) cameras, Near-field communication (NFC) or wearable sensors, ad-hoc network and/or Bluetooth devices.

Current contextual activities of a user may be inferred, for example, based on monitoring via IP cameras, wearables and conversation detection. Examples of a user inferred current contextual activities may include the following: User J may be calling User E while doing his homework; User J may want to talk to his parents or relatives while walking his dog in the park; User J may want to call his friend(s) on a speaker phone while playing video games. Based on inferred contextual situations (e.g., user activity) and with whom the user communicates (e.g., calls and/or messages), a correlation regression method is invoked that predicts the caller and organizes the contact entry list in a systematic fashion.

Various affinity measures (e.g., cognitive, affective and contextual properties) between a profile of the first user and each contact entry from the first user's contact entries are then determined from the identified behavioral aspects of the user and additional data points such as calendar data, sensor data recording, various native and instrumented sensors on a user computing device (e.g., mobile device). In one implementation, in some embodiments, the identified or learned behavioral aspects of the user is used as input parameters, e.g., to a neural network algorithm/model with re-configurable weighted vectors. The neural network model outputs a recommendation or actual interface model showing the arrangement of different contact entries in an orderly fashion. The method of identifying or learning the behavior aspects of the user can be done for individual contact entry or cohort, e.g., based on inferred frequency of the first user contacting or communicating with a specific contact entity. For instance, frequency of conversation with a specific person can determine the level of engagement, formality or informality level. The frequency of conversation can be correlated with contextual situation in the neural network model in determining the prediction output. The determined affinity measures are further refined to fine-granular levels through analyzing of historical behavioral aspects. In one aspect, the affinity measures are determined by analyzing and correlating the affinity properties.

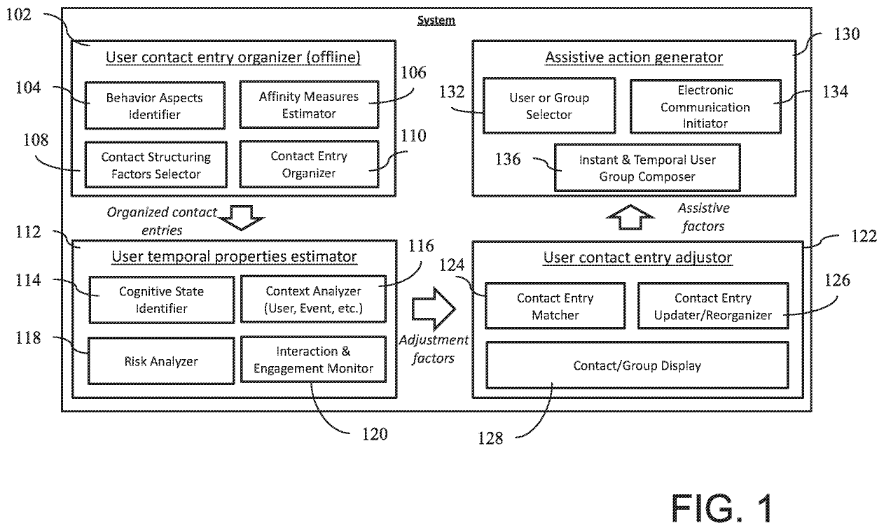

FIG. 1 is a block diagram illustrating components of a computing system, which dynamically structures and actuates (e.g., taking an action like triggering an artificial intelligence (AI) bot) contact entities for a user based on predicted temporal properties. The components shown may be implemented as software components or functionalities executing on a hardware processor. In another aspect, components of the system may include hardware components programmed to perform the respective functionalities. In one aspect, the system receives a first user's contact entries (e.g., phone contacts, social networking contact or profile), infers affinities between a profile of the first user and each contact entry from the first user's contact entries, and adjusts the first user's contact entries in real-time on a user device in response to inferring the affinities. The system may also dynamically add contact entries in the contact list based on detection of a “likely to contact person or group” from different social network affiliations.

Using the affinity measures, the system may structure or adjust the user contact entries, wherein each contact entry may be assigned specific cognitive, affective and/or contextual scores/weights. For instance, the system may structure contact entries in relative order of the first user and create semantic links among contact entries. Additionally, the system may further characterize the contact entries according to numbers on speed dial, recent contact list, time and event based categorization of members involved in the list; and may learn to infer current contextual activities such as playing video games, doing homework, walking a dog in the park, reading news, and/or others, from user's calendar data, sensor data recording, history pattern analysis based on timestamp and location metrics.

In some embodiments, the system may take into consideration the analysis of previous communication or interaction effectiveness with one or more second users or groups in the first user contact entries. By way of an example, the effectiveness may include amount of time a second user has taken to respond to the first user's communication request (e.g., call or message response). Using machine learning models, the content of a conversation between the first and second users may be analysed or predicted to establish the context of the conversation. In further embodiment, the impact of the response time on the analysed conversation is assessed and corelated.

Each contact entry is updated based on inferred affinities (of cognitive, affective and contextual properties) and other factors such as effectiveness of response time in the past, by stacking the contact list or displaying the most probable user on top of the user's list in contact entries.

A user contact entry organizer component 102 may include functionalities such as a behavior aspects identifier 104, affinity measures estimator 106, contact structuring factors selector and a contact entry organizer. In one aspect, the user contact entry organizer 102 may perform its functions offline. In another aspect, the user contact entry organize 102 may perform its functions online or in real time. When the need to structure a user contact entry is established at a time T, the user contact entry organizer 102 first queries the contact structuring factors selector 108 to obtain specific contact structuring factors; second, it iterates through each contact entry of the user and organizes the contact entries. The user contact entry organizer 102 may employ heuristic/rule based or machine learning based techniques (e.g., deep learning mixture model, K-means clustering decision tree, and/or other techniques), for instance, different from iterating through each contact entry. The organized contact entries are stored in a user's contact database and linked with the user profile.

A user temporal properties estimator component 112 may include functionalities such as a cognitive state identifier 114, context analyzer 116, risk analyzer 118, and interaction and engagement monitor 120. The interaction and engagement monitor 120 may monitor the first user's interaction and engagement performed via a user's device, for example, user's usage of a phone, user's activities (e.g., scrolling fast on the contact entry, switching pattern of a user from one application to another) on the phone or one or more applications installed on the phone, user facial expression (e.g., determined using in-built camera on the user phone and deep neural network model to perform visual analytics), text messaging, electronic mail, and/or others. The cognitive state identifier 114 may determine a first user's current cognitive state, for example, based on input data such as the user's expression from camera/image data, amount of agitation in the user's voice, for example, from audio data, and others, for instance, retrieved via the interaction and engagement monitor 120, from one or more IoT enabled user computing devices such as activity tracking devices like a smartwatch or another. The context analyzer 116 may determine the first user's current context, for instance, based on input data such as data from one or more IoT enabled computing devices activity tracking devices like a smartwatch and other sensor data that provides clues to the current user context or environment setting. The risk analyzer 118 may compute a risk score associated with the current user's context. In one implementation scenario, the risk analyser 118 may first establish an urgency level of the user to contact a secondary user or a group of users for an emergency situation, an importance level of the user to contact the appropriate secondary user or group of users based on his/her current cognitive or affective situation, or a user difficulty level (e.g., from the user profile the user is determined to have low literacy, known communication issues). The risk analyser 118 may compare the urgency level, the importance level and the difficulty level with predetermined threshold values and then assigns a risk score, for example, in the scale of 1 to 5 wherein 5 represents Very High, 4 represents High, 3 represents Medium, 2 represents Low, and 1 represents Very Low.

In one aspect, the contact entries may be organized offline as shown at 102. The offline organized contact entries may be used by real-time contact organizer, e.g., 112 and 122. In one embodiment, organized contact entries may be stored in a user contact database, which may be used and/or updated by the remaining components of the system, e.g., components of 112, 130 and 122.

A user contact entry adjust component 122 may include functionalities such as a contact entry matcher 124, contact entry update/reorganizer 126 and contact/group display 128. The contact entry matcher 124 may find or identify a second user or a second user group (a group of second users) most appropriate for the first user to contact given the first user's current cognitive state and context. In one aspect, the contact entries are organized or clustered (e.g., using a K-means clustering algorithm, a decision tree algorithm or the like) according to various affinities. The contact entry matcher 124 may compare the cluster or leaf node to find or identify exact or closest secondary user or group of users based on the given first user's current cognitive state, context. The contact entry update/reorganizer 127 may restructure the contact entry of the user, for example, generated by the user contact entry organizer 102 according to the result of the contact entry matcher 124. The contact/group display 128 may display or present the second user or group. An assistive action generator 130 also may be triggered responsive to finding a second user or a second user group, for example, by the contact entry matcher 124. The assistive action generator 130 may include functionalities such as a user or group selector 132, electronic communication initiator 134 and instance and temporal user group composer 136. The user or group selector 132 may select a second user or second user group to contact. The electronic communication initiator 134 initiates or trigger a communication with a selected second user or second user group, for example, places a phone call, sends a text message, sends an email message, or initiates another contact or communications mechanism, connecting the first user with the second user or the second user group. The instant and temporal user group composer 136 may create a user group, which includes the selected one or more of second users, via which the first user may make contact with the second user or second user group.

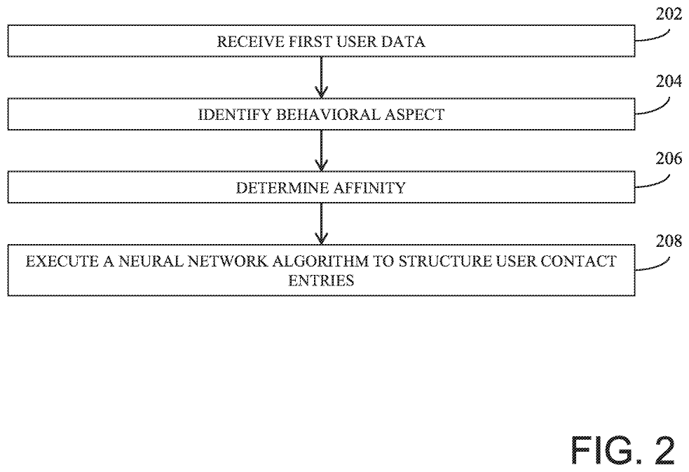

FIG. 2 is a flow diagram illustrating adjusting of a user contact entry using affinity measures, according to one embodiment. At 202, a first user data is received. The received data may include contact entries such as phone contacts, social networking contacts, historical user interaction and engagement data, historical user cognitive, affective and contextual situations associated with a specific event, historical response times of a secondary users or groups, historical user conversations, real-time monitored data stream from IoT enabled computing devices. Such contact information may be stored by the respective devices and/or apps (e.g., phone, social network app), and can be retrieved from the memory or storage associated with the respective devices and/or apps. The received data may also include data points such as calendar data associated with the first user, sensor data recordings associated with the first user, for instance, recorded via various native and instrumented sensors embedded in the first user's computing device or devices, and/or other additional data points. Such information may be also retrieved from the memory or storage associated with the computing device or devices. Using the first user data, the method may include training various custom statistical and predictive machine learning models (e.g., K-means clustering technique to organize and cluster contact entries, a decision tree model to optimize matching of contact entry lookup, a deep neural network model to perform visual analytics). These models are configured with the system to operate in offline and/or online modes.

At 204, at least one behavioral aspect of the first user may be identified based on one or more machine learning models trained using the first user data. Examples of a behavioral aspect may include, but are not limited to, the first user's cognitive or affective state, and contextual state. In one aspect, the behavioral aspect of the first user is identified in relation to other users (one or more second users) in the first user's contact entries. In one aspect, the behavioral aspect of the first user is identified based on the received first user data. Additional data sources may be used to identify the first user's behavioral aspect.

At 206, one or more affinities stored in a user profile database is determined between a first user and each contact entry based on the first user data and at least one behavioral aspect of the first user.

At 208, the first user's contact entries are structured or adjusted in memory, by feeding the determined one or more affinities to a neural network algorithm or model with re-configurable weighted vectors. For example, input features to the neural network model may include frequency of conversation with a specific party/entity; time and day of conversation with specific entity; conversation analysis (via natural language processing (NLP) and MFCC speech features extraction); user's activity (contextual situation detected via enabling sources by recurrent convolutional neural network (R-CNN) and pattern recognition: IP cameras, wearable devices, ad-hoc network); current contact entry list (device monitoring). Inputs like speech features, conversation analysis and contextual situations may be multi-dimensional input matrices which are fed into the model. Using the word to vector technique on the input features, the numerical matrix for the inputs may be created. The output is able to cluster the set of contact entries based on the contextual situations. A correlation engine, for instance, matches the contextual situation and user's contacts in order to determine the output of organizing/arranging the contact entries list in user's linked devices.

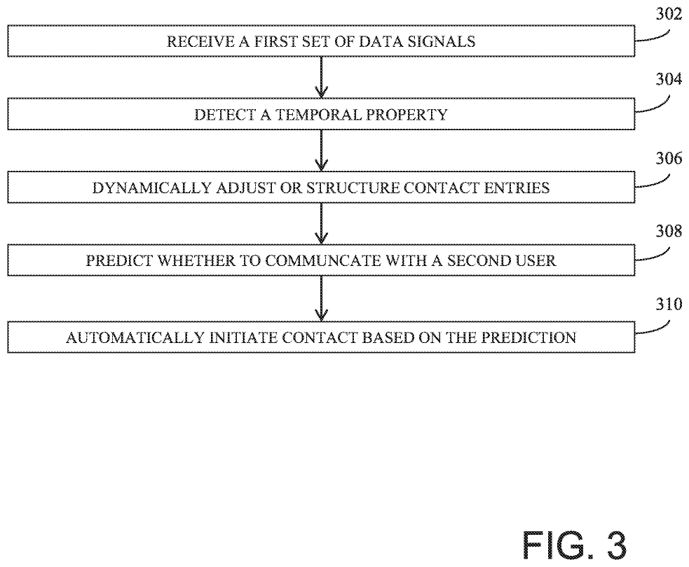

FIG. 3 is a flow diagram illustrating a method of dynamically adjusting contact entries based on detected or predicted temporal properties of a user in real-time, according to one embodiment. The method is performed by a hardware processor. The hardware processor, for instance, may be a processor on a smartphone, a processor running an app, a processor on a computer, or another. At 302, a first set of data signals is received from a first user device.

At 304, one or more temporal properties of the first user are detected from the received data signals. Examples of a temporal property may include, but are not limited to, the user's cognitive state at a specific time or temporal period, and contextual factors associated with the user's context or environment at a specific time or temporal period such as a temporary characteristic and event specific factor.

At 306, the first user's contact entries are dynamically adjusted or structured in a memory device associated with the first user's device or app, in response to the detected one or more temporal properties, or detecting one or more temporal properties.

At 308, a prediction is made as to whether the first user is to contact or communicate with one or more second users in the first user's contact entries, for example, make a phone call, send a message (e.g., text or email or another), and/or communicate in another manner, e.g., using the first user's device. In one aspect, the prediction is made responsive to detecting one or more temporal properties of the first user.

At 310, a communication or contact may be automatically initiated, for example, by triggering a phone call to be made on the first user's smartphone, a message to be sent via an app on the first user's smartphone, based on the prediction.

Detecting and/or predicting real-time temporal properties of a user may assist the user, in following example scenarios.

Example scenario 1: A method of the present disclosure may detect that a first user is in an “agitated” or “nervous” state, and would like to contact a second user; the method of the present disclosure may dynamically adjust the contact entries on the first user's device or app, and for example, may create an instant group of second users, whom the user can contact easily. In this regard, a user interface of an app or device providing the contact entries may be re-adjusted or created, for allowing the user to conveniently select an appropriate second user.

Example scenario 2: A method of the present disclosure may detect that a first user is in a panic mode and has only a short time (e.g., 1 minute) to call or message a second user; the method of the present disclosure may automatically adjust contact entries as a function of time such that the first user can immediately contact a second user.

Example scenario 3: A method of the present disclosure may detect that a first user is in a “bored” state and that the first user picked up a phone to call a second user or user group available in the contact entries; the method of the present disclosure can dynamically adjust contact entries, and may also suggest whom to contact in that particular situation, for example, when the first user in that cognitive state and looking to converse with another user.

Example scenario 4: A method of the present disclosure may detect that a first user is in a dangerous situation, for example, in a disaster situation. The method of the present disclosure may also detect that there is a second user in the first user's contact entries, physically located nearby in the area of the first user, who can pick up the first user. The method of the present disclosure further detects, however, that the battery or power source on the first user's device (e.g., smartphone) is about to deplete or almost depleted (e.g., 10% or another defined percentage left). The method of the present disclosure may, in response, automatically select an assistant (using the assistive action generator 130) that calls or contacts the second user and provides location information of the first user. The selected assistant can be a cloud enable artificial intelligence (AI)-agent, another computing device, and/or the detected second user in the first user's contact entries. In one aspect, the system further triggers the selected assistant to pick up the first user or coordinate the picking up of the first user.

Example scenario 5: A method of the present disclosure may detect that a first user is looking for a recommendation associated with a product, e.g., “where to buy strawberries”, from one or more second users in the user's contact entries or list. Rather than having the first user search for the second user who can provide the information, the method of the present disclosure may, based on affiliation from different social media platforms or contact, suggest one or more second users to call or contact.

In some embodiments, a method of the present disclosure determines temporal properties (e.g., cognitive state, contextual factors including, for example, environment factors and event specific factors at a specific time or the current time) of the user in real-time from input sources. This may include receiving, by a computing system or a hardware processor, a first set of data signals from the first user devices, and based on the first set of data signals, determining the temporal properties. For instance, the method may perform a gait analysis that may use sound/cadence, computer vision without red-green-blue (RGB), for example, which can determine who is walking. The method may also perform sensing from onboard sensors (e.g., from a user mobile device, smart-watch, smart-eye lenses, and/or others) or other sensors. The method may also perform a sound analysis to know the stress level of the use. The method may also include inferring the cognitive state from facial recognition or image recognition using a trained deep neural network model. The method may also include performing an analysis of accelerometer data, which may indicate the speed and motion of the user. The method may also learn from historical data to determine the first user's cognitive state and context. Based on the determined temporal properties, temporal characteristic of the user can be established in real-time to guide the assistive action generation.

Based on, or responsive to determining or detecting in real time, the determined one or more temporal properties of the first user, the method may also predict whether the first user needs to or wants to contact or communicate with a possible second user or group of second users (e.g., making a phone call, sending a message on an app to an individual or groups). The method in one embodiment may include dynamically selecting a contact entry from the user contact database or composing a group of second users based on existing contact entries in user contact database. Composing a group of secondary users may include comparing and matching each secondary user's contact entry against their affinity measures; secondary users who are not necessary in the same cluster may be part of the new group based on specific affinity measure that matches with the new group/cluster criteria. The dynamic selecting may also generate or recommend an optimal (e.g., based on risk assessment) second user as a temporary contact or communication to assist the first user effective way.

In some embodiments, based on one or more temporal properties of the first user detected and also based on performing further risk analysis, the method may further include performing the following: Stacking the contact list or displaying the most probable user on top of the user's list in contacts; Creating configurable speed-dials dynamically in graphical user interfaces (GUIs) of the respective devices for easily accessing the user's contact information; Dynamically grouping a specific group of users into speed dial format or arranging the contact entries n a prioritized fashion; Displaying different group of contacts in different user's devices based on type of devices used to engage with a specific entity; Initiate message or alternate form of communication between the first user and the most probable point of contact by understanding the pattern history, performing a conversation detection analysis and assessing the contextual affinity of the user pertaining to cognitive state; Establishing conference grouping of selective contacts based on historical analysis and cognitive state of the first user pertaining to a contextual situation; Activating a bot/assistant to perform an action based on user need.

In some embodiments, contact entries may be updated dynamically based on the one or more temporal properties of the first user. An update of a contact entry may include, but are not limited to, updating previously stored response time of a second user responding to the first user with a new computed value, updating previously recorded interaction and engagement of the user with one or more device or applications based on monitored values, updating values of one or more affinities (e.g., newly learned cognitive and contextual states).

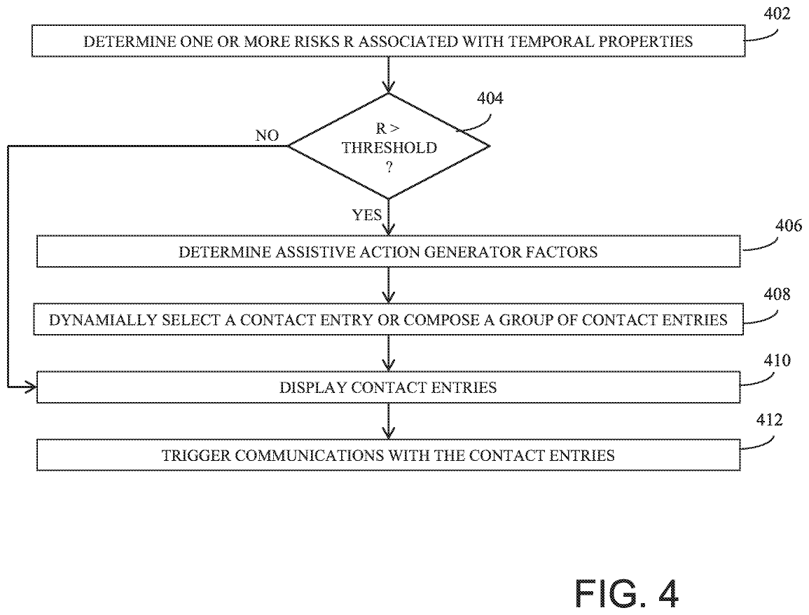

FIG. 4 is a flow diagram illustrating a method of dynamically generating user assistive actions, according one embodiment. At 402, a risk associated with temporal properties predicted or determined of a first user is determined, for instance, by performing a risk analysis. For instance, a risk score may be computed.

At 404, it is determined whether the risk or the risk score exceeds a configured or predefined threshold risk value.

At 406, assistive action generator factors are determined based on the risk score and the user's current cognitive state and contextual situation. In one embodiment, assistive action generator factors include factors that cause the system to select or generate one or more of assistive actions. Examples of these actions may include, but are not limited to: stacking the contact list or displaying the most probable user on top of the user's list in contacts; creating configurable speed-dials dynamically in the GUI of the respective devices for easily accessing the user's contact information; dynamically grouping a specific group of users into speed dial format or arranging them in a prioritized fashion; displaying different groups of contacts in different user's devices based on types of devices used to engage with a specific entity; initiating a message or alternate form of communication between the user and the most probable point of contact by understanding the pattern history, conversation detection analysis and assessing the contextual affinity of the user pertaining to cognitive state; establishing a conference grouping of selective contacts based on historical analysis and cognitive state of the user pertaining to a certain contextual situation; activating a bot or like automated assistant to perform an action based on user need. Determining one or more assistive actions can be done via one or more of a rule-based or machine learning based approach. In the rule-based approach, rules can be predefined and configured with the system of the present disclosure so that if a predefined threshold risk value is reached, one or more rules can be used to activate or select one or more assistive actions. In the machine learning case, in one embodiment, the system uses models to perform the generation of assistive actions.

At 408, in one embodiment, based on the assistive action generator factors, a contact entry may be dynamically selected, and/or a group of second users may be dynamically composed.

At 410, the selected contact entry or entries are displayed. In one aspect, contact entries are adjusted in the first user's device and displayed. For instance, the selected contact entry may appear on the first user's device in the form of a speed dial.

At 412, the selected contact entry may be automatically or autonomously contacted.

In one embodiment, a data structure associated with a user may be implemented as follows, where X represents a user. Xᵢ input features, where i=1 to N, and i represents i-th feature, out of N features, may be pre-processed.

X₁=current activity (e.g., determined from sensor feeds and/or other data source);
X₂=cognitive state detection (e.g., inclusive of mood detection); e.g., <X_{2,1}=Frustration, X_{2,2}=Aggression, X_{2,3}=Calm, X_{2,4}=Panicky, X_{2,5}=Happy, X_{2,6}=Nervous, . . . >; In some embodiments, X₂ vector can be reduced from variations of mood levels to basic cognitive levels. Principal component analysis (PCA) may be performed on X₂ feature vector initially for correct assessment and dimensionality reduction of user's cognitive state to be later fed into the conglomerate input feature Xᵢ; For instance, if the speech features or user's mood is a multi-dimensional vector matrix, PCA helps in feature pruning (e.g., by only monitoring essential features and ignoring the rest) by reducing the 3D matrix to a 2D matrix which helps in evaluation of output at a faster rate.
X₃=contact entry list;
X₄=user's relationship with respective entries in contact lists;
X₅=annotations and tags (e.g., metadata information associated with each entity or user entry in the contact list, which is determined by performing NLP based semantic and syntactic information processing); Annotations and tags can be created by transcribing the conversation occurring on the phone or like device, using a speech to text conversion tool and then understanding the topic of conversation by NLP for extracting keywords to determine the context for a given user. Annotations and tags helps in answering queries related to what, when, who. (E.g., walking |dog|park| second user's name or “Home”|“Study”|“Exam”|Second user's name).
X₆=geo-spatial and temporal metrics; e.g., current location in latitude, longitude geographic coordinates (or another location identification), current time.
Σᵢ₌₁^{N} Xᵢ=<current activity, cognitive state detection, contact entry list, user's relationship with respective entries, user's metadata information>, wherein each parameter are time stamped and geo- or location stamped.

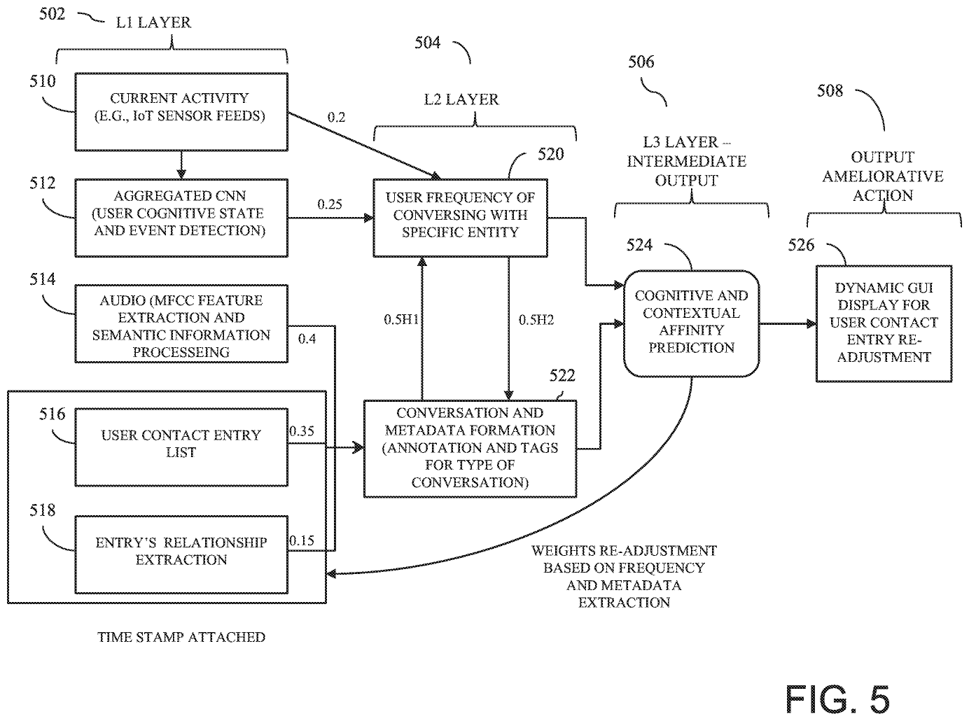

FIG. 5 shows an implementation example of a three-layer neural network model illustrating contact adjustment based on multiple weighted parameters trained over configurable time period T, in one embodiment. The first layer 502 may include the above described Xᵢ input features, for example, current activity 510, user cognitive state detected 512, metadata information (e.g., extracted from received audio data) 514, user contact entry list 516, and each entry's (in the user's contact list) relationship to the user 518.

For instance, the current activity 510 may be determined from data sources such as the Internet of Things (IoT) sensor feeds. User's cognitive states or state and/or event 512 may be determined, for example, by implementing and building a convolutional neural network (CNN) algorithm/model, which learns to recognize to classify a particular user's moods or cognitive states based on input features such as the user image expressions. Metadata information 514 may be extracted from data sources such as audio data, for example, by performing Mel Frequency Cepstral Coefficient (MFCC) extraction and semantic information processing. Metadata, for example, is associated with a specific user, and may include data extracted from conversation detection and topical information analysis. User contact entry list 516, for instance, may be retrieved from the user device's memory or storage or a user's app, which retrieves contact entries associated with the app. Contact entry's relationship 518 may be determined from analyzing the contact entries.

The second layer vectors Hᵢ may take the previous input weights and feed the input weights into conglomerate intermediate features which include: H1=frequency of conversing with specific user entity 520; and H2=Conversation detection (e.g., additional information for reinforced training model) 522. H1 and H2 are variables of a hidden layer in the neural network, and have associated weights (e.g., shown as 0.5h1 and 0.5h2 for example purposes only). The weights can be refined over periods of time via feedback learning.

In this neural network architecture, the input features comprising current activity 510 and user cognitive state 512 of L1 layer 502 are connected to the node 520 of the second layer 504, which node 520 represents frequency of conversing with specific user entity. The input features comprising metadata 514, user contact entry list 516 and entry's relationship 518 are connected to the node 522 of the second layer 504, which node 522 represents conversation information. The connections between the nodes are weighted.

The third layer 506 may include the output layer which represents the affinity of the respective user with respect to specific conversation and the probability of user selecting the respective user to engage in a conversation based on contextual activity and cognitive state of the user 524. In one embodiment, previous input features are combined together to generate the probabilistic output of arranging the contacts in orderly fashion. A numerical value is assigned to other users on the call/conversation. In one embodiment, an output is generated that includes a systematic fashion of numbered matrix showcasing the ordering of contact entries based on the contextual situation.

In one aspect, principal component analysis (PCA) can be implemented for dimensionality reduction for cognitive activity and cognitive state parameters initially. Then the parameters can be assessed while they are fed as simplified vectors into the multi-level neural network system.

The fourth layer of the neural network model shown in FIG. 5 represents an output comprising an ameliorative action, for instance, which can be presented in a dynamic GUI display showing contact entry re-adjustment.

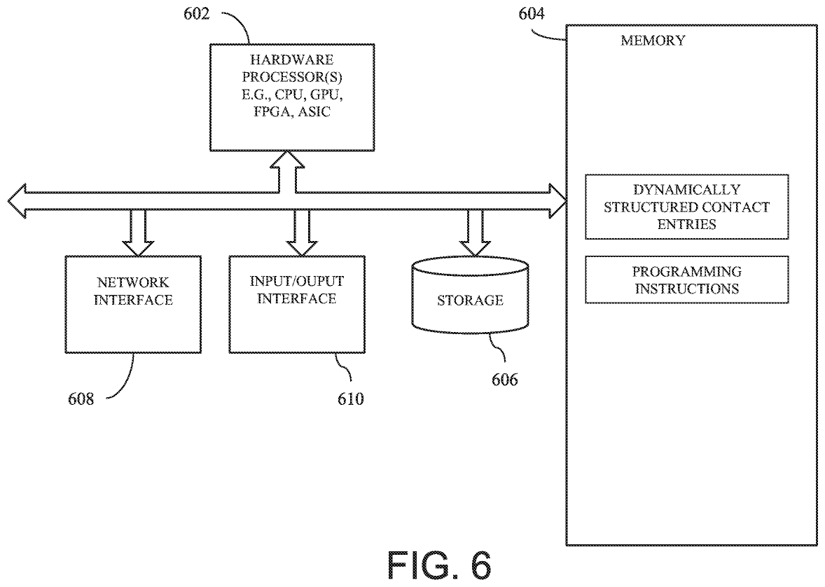

FIG. 6 is a diagram showing components of a system in one embodiment, which simplifies electronic communication based on dynamically structured or adjusted contact entries. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and dynamically structure contact entries of a user's device or app, based on determining a user's current cognitive state and context. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium. The memory device 604 may, for example, store instructions and/or data for functioning of the one or more hardware processors 602, and may include an operating system and other program of instructions and/or data. The one or more hardware processors 602 may receive input comprising a first set of data signals from a first user device associated with a first user. For instance, at least one hardware processor 602 may detect temporal properties associated with the first user from the first set of data signals. The temporal properties may include at least a current cognitive state of the first user and environment context associated the first user. Responsive to detecting the temporal properties, at least one hardware processor 602 may dynamically structure contact entries associated with the first user device, select at least one second user from the dynamically structured contact entries; and trigger the first user device to initiate a communication with the at least one second user via the first user device. In one aspect, structured contact entries may be stored in a storage device 606 or stored on memory 604. The structured contact entries can be stored into a user contact database that can be dynamically linked with a user profile. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

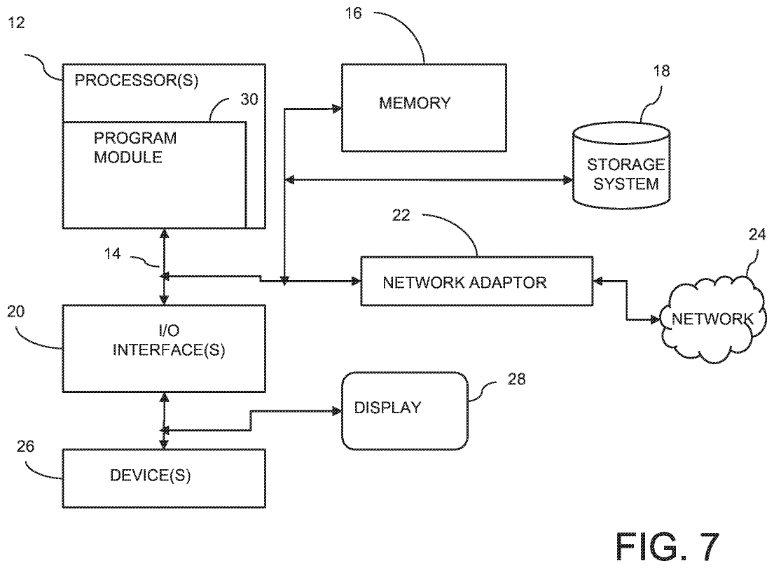

FIG. 7 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, the method performed by a hardware processor, the method comprising:
receiving a first set of data signals from a first user device associated with a first user;
detecting temporal properties associated with the first user from the first set of data signals, the temporal properties comprising at least a current cognitive state of the first user and environment context associated the first user;
responsive to detecting the temporal properties, dynamically structuring contact entries associated with the first user device;
selecting at least one second user from the dynamically structured contact entries; and
triggering the first user device to initiate a communication with the at least one second user via the first user device.

2. The method of claim 1, wherein the selecting and the initiating are performed responsive to predicting based on the temporal properties a likelihood that the first user will contact the at least one second user.

3. The method of claim 1, wherein the dynamically structuring contact entries comprises
identifying at least one behavioral aspect of the first user in relation to each of the contact entries based on the first set of data signals and a second set of data signals comprising metadata associated with conversations occurring between the first user and said each of the contact entries;
inferring cognitive and contextual affinity between the first user and said each of the contact entries, based on the first set of data signals and the at least one behavioral aspect of the first user; and
structuring the contact entries with the inferred cognitive and contextual affinity.

4. The method of claim 3, wherein the inferring cognitive and contextual affinity further considers analyzing previous communication history between the first user and the contact entries.

5. The method of claim 3, wherein the dynamically structuring contact entries associated with the first user device further comprises dynamically grouping the contact entries into groups of specific electronic modalities, based on the cognitive and contextual affinity.

6. The method of claim 5, wherein the dynamically grouping the contact entries comprises creating speed dial groups.

7. The method of claim 3, wherein the dynamically structuring contact entries comprises implementing a machine learning model trained to dynamically structure the contact entries.

8. The method of claim 7, wherein the machine learning model comprises a neural network model architected to comprise:
a first layer of nodes comprising a current activity node, a user cognitive state node, a metadata node, a contact entry list node and an entry relationship node;
a second layer of nodes comprising a user frequency of conversing with specific entity node and a conversation and metadata formation node, wherein the user frequency of conversing with specific entity node and the conversation and metadata formation node are connected;
a third layer node comprising a cognitive and contextual affinity prediction node; and
an output node comprising dynamically structured contact entries;
wherein the current activity node and the user cognitive state node are connected to the user frequency of conversing with specific entity node via respective weighted edges,
wherein the metadata node, the contact entry list node and the entry relationship node are connected to the conversation and metadata formation node via respective weighted edges,
wherein the user frequency of conversing with specific entity node and the conversation and metadata formation node are connected to the cognitive and contextual affinity prediction node, and the cognitive and contextual affinity prediction node is connected to the output node.

9. The method of claim 7, further comprising storing the structured contact entries into a user contact database that can be dynamically linked with a user profile.

10. A computer readable storage medium storing a program of instructions executable by a machine to perform a method comprising:
receiving a first set of data signals from a first user device associated with a first user;
detecting temporal properties associated with the first user from the first set of data signals, the temporal properties comprising at least a current cognitive state of the first user and environment context associated the first user;
responsive to detecting the temporal properties, dynamically structuring contact entries associated with the first user device;
selecting at least one second user from the dynamically structured contact entries; and
triggering the first user device to initiate a communication with the at least one second user via the first user device.

11. The computer readable storage medium of claim 10, wherein the selecting and the initiating are performed responsive to predicting based on the temporal properties a likelihood that the first user will contact the at least one second user.

12. The computer readable storage medium of claim 10, wherein the dynamically structuring contact entries comprises
identifying at least one behavioral aspect of the first user in relation to each of the contact entries based on the first set of data signals and a second set of data signals comprising metadata associated with conversations occurring between the first user and said each of the contact entries;
inferring cognitive and contextual affinity between the first user and said each of the contact entries, based on the first set of data signals and the at least one behavioral aspect of the first user;
structuring the contact entries with the inferred cognitive and contextual affinity; and
storing the contact entries into a user contact database that can be dynamically linked with a user profile.

13. The computer readable storage medium of claim 12, wherein the inferring cognitive and contextual affinity further considers analyzing previous communication history between the first user and the contact entries.

14. The computer readable storage medium of claim 12, wherein the dynamically structuring contact entries associated with the first user device further comprises dynamically grouping the contact entries into groups of specific electronic modalities, based on the cognitive and contextual affinity.

15. The computer readable storage medium of claim 12, wherein the dynamically structuring contact entries comprises implementing a neural network model trained to dynamically structure the contact entries, the neural network model architected to comprise:
a first layer of nodes comprising a current activity node, a user cognitive state node, a metadata node, a contact entry list node and an entry relationship node;
a second layer of nodes comprising a user frequency of conversing with specific entity node and a conversation and metadata formation node, wherein the user frequency of conversing with specific entity node and the conversation and metadata formation node are connected;
a third layer node comprising a cognitive and contextual affinity prediction node; and
an output node comprising dynamically structured contact entries;
wherein the current activity node and the user cognitive state node are connected to the user frequency of conversing with specific entity node via respective weighted edges,
wherein the metadata node, the contact entry list node and the entry relationship node are connected to the conversation and metadata formation node via respective weighted edges,
wherein the user frequency of conversing with specific entity node and the conversation and metadata formation node are connected to the cognitive and contextual affinity prediction node, and the cognitive and contextual affinity prediction node is connected to the output node.

16. A system, comprising:
at least one hardware processor coupled with a memory device,
the at least one hardware processor operable to:
receive a first set of data signals from a first user device associated with a first user;
detect temporal properties associated with the first user from the first set of data signals, the temporal properties comprising at least a current cognitive state of the first user and environment context associated the first user;
responsive to detecting the temporal properties, dynamically structure contact entries associated with the first user device;
select at least one second user from the dynamically structured contact entries; and
trigger the first user device to initiate a communication with the at least one second user via the first user device.

17. The system of claim 16, wherein the selecting and the initiating are performed responsive to predicting based on the temporal properties a likelihood that the first user will contact the at least one second user.

18. The system of claim 16, wherein the dynamically structuring contact entries comprises
identifying at least one behavioral aspect of the first user in relation to each of the contact entries based on the first set of data signals and a second set of data signals comprising metadata associated with conversations occurring between the first user and said each of the contact entries;
inferring cognitive and contextual affinity between the first user and said each of the contact entries, based on the first set of data signals and the at least one behavioral aspect of the first user;
structuring the contact entries with the inferred cognitive and contextual affinity;
storing the contact entries into a user contact database that can be dynamically linked with a user profile.

19. The system of claim 18, wherein the inferring cognitive and contextual affinity further considers previous communication between the first user and the contact entries.

20. The system of claim 18, wherein the dynamically structuring contact entries comprises implementing a neural network model trained to dynamically structure the contact entries, the neural network model architected to comprise:
a first layer of nodes comprising a current activity node, a user cognitive state node, a metadata node, a contact entry list node and an entry relationship node;
a second layer of nodes comprising a user frequency of conversing with specific entity node and a conversation and metadata formation node, wherein the user frequency of conversing with specific entity node and the conversation and metadata formation node are connected;
a third layer node comprising a cognitive and contextual affinity prediction node; and
an output node comprising dynamically structured contact entries;
wherein the current activity node and the user cognitive state node are connected to the user frequency of conversing with specific entity node via respective weighted edges,
wherein the metadata node, the contact entry list node and the entry relationship node are connected to the conversation and metadata formation node via respective weighted edges,
wherein the user frequency of conversing with specific entity node and the conversation and metadata formation node are connected to the cognitive and contextual affinity prediction node, and the cognitive and contextual affinity prediction node is connected to the output node.
